(19) United States
(12) Patent Application Publication
(10) Pub. No.: US 2018/0011200 A1
(43) Pub. Date: Jan. 11, 2018

(54) SATELLITE SIGNAL EXCLUSION BASED ON DOPPLER INFORMATION

(71) Applicant: QUALCOMM Incorporated, San Diego, CA (US)

(72) Inventors: Madhukar RAMAMURTHY, Bikashipura (IN); Gowthami ITTA, Bangalore (IN); Vivek GARG, Gurgaon (IN)

(21) Appl. No.: 15/202,701

(22) Filed: Jul. 6, 2016

(51) Int. Cl. G01S 19/25; G01S 19/42; G01S 19/41; G01S 19/52; G01S 19/51

(52) U.S. Cl. CPC G01S 19/254; G01S 19/52; G01S 19/51; G01S 19/41; G01S 19/423; G01S 19/425

(57) ABSTRACT

A device that includes a receiver that receives multiple positioning signals from a satellite, including a positioning signal and remaining positioning signals, and a processor communicatively coupled to the receiver. The processor determines a speed value of the device based on a Doppler shift of the positioning signal. The speed value is a magnitude of a velocity of the device in a direction. The processor also determines that the speed value is not consistent with at least one other measurement and determines the position of the device using the remaining positioning signals.

### BACKGROUND

Conventional global navigation satellite system (GNSS) receiver systems are able to determine a location of the receiver by receiving GNSS signals from GNSS satellites. However, multi-path signals, especially prevalent in urban canyon environments (e.g. city) for example, corrupt the received GNSS signals, thereby leading to inaccurate measurements and navigation solutions.

Some of these conventional GNSS receivers attempt to mitigate the negative effects of multi-path signals by rejecting or re-weighting the contribution of these signals to the navigation solution. Rejection of at least some of the inaccurate measurements may be performed, for example, during computation of the navigation solution using a Kalman Filter.

### SUMMARY

An example of a device includes a receiver configured to receive positioning signals from a satellite, wherein the positioning signals includes a positioning signal and remaining positioning signals; and a processor, communicatively coupled to the receiver, configured to: determine a speed value of the device based on a Doppler shift of the positioning signal, the speed value being a magnitude of a velocity of the device in a direction; determine that the speed value is not consistent with at least one other measurement; and determine the position of the device using the remaining positioning signals.

Implementations of such a device may include one or more of the following features. The at least one other measurement may include remaining speed values of the device determined based on Doppler shifts of respective ones of the remaining positioning signals, the remaining speed values being magnitudes of velocities of the device in respective directions. The processor may be configured to determine that the speed value is not consistent with the at least one other measurement by determining that the speed value is an outlier relative to the remaining speed values. The processor may be configured to determine that the speed value of the device is an outlier if the speed value of the device is greater than an upper threshold or less than a lower threshold. The processor may be configured to determine the upper threshold and the lower threshold based on the remaining speed values. The speed value may be a magnitude of the velocity of the device in a line of sight direction from the device to the satellite. The processor may be configured to determine a heading of the device and to determine the speed value of the device the processor may be configured to use the heading of the device. To determine the speed value the processor may be configured to calculate

$$ψ = [ 1 - cos β cos ( α - φ - δφ ) ] [ \begin{matrix}f \\ {v}_{f}\end{matrix} ] + ɛ$$

where α is an azimuth of the satellite; β is an elevation of the satellite; φ is the heading of the device; δφ is an error in a measurement of the heading, φ; v_{f} is the speed value being determined; f is a clock drift of the device relative to the satellite; ψ is a measured quantity related to the Doppler shift of the first positioning signal; and E is an error in ψ due to the device. The device may further include a heading sensor and to determine the heading of the device the processor may be configured to receive the heading from the heading sensor. The heading sensor may include at least one of an electronic compass, a gyroscope, map data from an application-level program, or a dead-reckoning sensor. The at least one other measurement may include a measures speed of the device received from a speedometer; and the heading received from the heading sensor. The processor may be configured to determine that the speed value is not consistent with the at least one other measurement by calculating an other speed value of the device relative to the satellite along the line of sight direction using the measured speed and the heading; and determining that the speed value is not within a threshold value from the calculated other speed value. The processor may be configured to determine a clock drift of the device in response to the device being stationary

An example of a method of operating a device includes receiving positioning signals from a satellite, the positioning signals including a positioning signal and remaining positioning signals; determining a speed value of the device based on a Doppler shift of the positioning signal, the speed value being a magnitude of a velocity of the device in a direction; determining that the speed value is not consistent with at least one other measurement; and determining the position of the device using the plurality of remaining positioning signals.

Implementations of such a method may include one or more of the following features. The at least one other measurement may include remaining speed values of the device determined based on Doppler shifts of respective ones of the remaining positioning signals, the remaining speed values being magnitudes of velocities of the device in respective directions. Determining that the speed value is not consistent with the at least one other measurement may include determining that the speed value is an outlier relative to the remaining speed values. The method may include determining that the speed value of the device is an outlier if the speed value of the device is greater than an upper threshold or less than a lower threshold. The method may include determining the upper threshold and the lower threshold based on the remaining speed values. The method may include determining the upper threshold and the lower threshold based on the standard deviation of the remaining speed values The speed value may be a magnitude of the velocity of the device in a line of sight direction from the device to the satellite. The mat include determining a heading of the device and determining the speed value may be based on the heading of the device. Determining the speed value the may include calculating

$$ψ = [ 1 - cos β cos ( α - φ - δφ ) ] [ \begin{matrix}f \\ {v}_{f}\end{matrix} ] + ɛ$$

where α is an azimuth of the satellite; β is an elevation of the satellite; φ is the heading of the device; δφ is an error in a measurement of the heading, φ; v_{f} is the speed value being determined; f is a clock drift of the device relative to the satellite; ψ is a measured quantity related to the Doppler shift of the first positioning signal; and E is an error in ψ due to the device. Determining the heading of the device may include receiving the heading from a heading sensor. The heading sensor may include at least one of an electronic compass, a gyroscope, map data from an application-level program, or a dead-reckoning sensor. The at least one other measurement may include a measures speed of the device received from a speedometer; and the heading received from the heading sensor. Determining that the speed value is not consistent with the at least one other measurement may include calculating an other speed value of the device relative to the satellite along the line of sight direction using the measured speed and the heading; and determining that the speed value is not within a threshold value from the calculated other speed value. The method may include determining a clock drift of the device in response to the device being stationary.

An example non-transitory processor-readable storage medium for a device with processor-readable instructions stored thereon includes instructions configured to cause a processor to: receive a plurality of positioning signals from a satellite, wherein the plurality of positioning signals includes a positioning signal and a plurality of remaining positioning signals; determine a speed value of the device based on a Doppler shift of the positioning signal, wherein the speed value is a magnitude of a velocity of the device in a direction; determine that the first speed value is not consistent with at least one other measurement; and determine the position of the device using the plurality of remaining positioning signals.

Implementations of such a method may include one or more of the following features. The at least one other measurement may include remaining speed values of the device determined based on Doppler shifts of respective ones of the remaining positioning signals, the remaining speed values being magnitudes of velocities of the device in respective directions. The instructions may be configured to determine that the speed value is not consistent with the at least one other measurement by determining that the speed value is an outlier relative to the plurality of remaining speed values.

An example of a device includes a receiving means for receiving positioning signals from a satellite, the positioning signals including a positioning signal and remaining positioning signals; speed determining means for determining a speed value of the device based on a Doppler shift of the positioning signal, the speed value being a magnitude of a velocity of the device in a direction; consistency determining means for determining that the speed value is not consistent with at least one other measurement; and position determining means for determining the position of the device using the plurality of remaining positioning signals.

The foregoing general description and the following detailed description with the accompanying drawings are examples that will provide a better understanding of the nature and advantages of the disclosure.

### BRIEF DESCRIPTION OF THE DRAWINGS

The above-mentioned features, as well as other features and advantages of the present technology will now be described in connection with various implementations, with reference to the accompanying drawings. The illustrated implementations, however, are merely examples and are not limiting. The relative dimensions of the following figures may not be drawn to scale.

FIG. 1 is a simplified diagram of a vehicle, with a global navigation satellite system (GNSS) receiver system, traveling through an urban canyon environment.

FIG. 2 is a data plot of scaled speed values as a function of time.

FIG. 3 is a data plot of speed values in a line of sight (LOS) direction as a function of time.

FIG. 4 is a block diagram of components of a global navigation satellite system (GNSS) receiver system.

FIG. 5 is a block diagram of components of a device that includes the GNSS receiver system in FIG. 4.

FIG. 6 is a flow diagram of a method of operating the device of FIG. 5.

FIG. 7 is a flow diagram of a method of operating the device of FIG. 5.

### DETAILED DESCRIPTION

Example techniques and devices are presented herein for identifying and excluding unreliable satellite signals (e.g., multi-path signals) from a calculation of a final navigation solution in a global navigation satellite system (GNSS) receiver system or a device that communicates with a GNSS receiver system. Not excluding unreliable satellite signals from the GNSS final navigation solution calculation may result in erroneous navigation solutions.

Excluding unreliable satellite signals from the calculation of the final navigation solutions typically, if not always, results in more accurate solutions. Moreover, the inventors have appreciated and recognized that the Doppler shift of a received satellite signal can be used to identify the received satellite signal as unreliable and this information may be used to exclude the received satellite signal from use in determining a navigation solution. For example, the Doppler shift of a satellite signal can be used to determine a speed value of the GNSS receiver system. This speed value can be compared to one or more other measurements to determine whether the speed value determined from the Doppler shift is consistent with the one or more other measurements. For example, the one or more other measurement may include speed values obtained from Doppler shifts of other satellite signals. Satellite signals associated with outlier speed values that are not clustered amongst the speed values associated with other satellite signals may be identified as unreliable and not used to determine a navigation solution. Alternatively, or additionally, a speed may be measured in one or more other ways such as by using an external speedometer (e.g., in the vehicle in which the GNSS receiver system is located) and a heading of the GNSS receiver may be measured using a heading sensor. These two measurements can be used to determine a second speed value of the GNSS receiver system relative to the satellite. The first speed value, determined from the Doppler shift measurement, may be compared to the second speed value to determine whether the two speed values are consistent.

In general, a GNSS receiver system, such as a global positioning satellite (GPS) receiver system, is a navigation system which determines its location (and therefore the location of the user of the system) by measuring the arrival times of signals received from multiple satellites in Earth's orbit and/or from pseudo-satellites (e.g., ground stations transmitting GPS signals, which will be considered a type of satellite herein). Each satellite transmits a positioning signal including a navigation message containing the time when the signal was transmitted and may also include ephemeris information which includes details about the satellite's orbit and corrections for the satellite's clock, in comparison with a universal or absolute time such as GNSS time. The ephemeris and clock correction parameters may collectively be known as ephemeris information. The ephemeris can, alternatively, be received from a source other than the satellite. For example, if the GNSS receiver system is part of a cellular mobile device, the ephemeris information may be received from a server via a cellular network. From the orbit information, the GNSS receiver system can determine the elevation angle (i.e., angle of the satellite position with respect to the horizon) and the azimuth angle (i.e., angle of the satellite position with respect to geodetic north) of each satellite.

In addition to the time and ephemeris information, the navigation message included in the positioning signal may contain satellite constellation almanac parameters representing the ionosphere and troposphere delay, time of week (TOW) information, Doppler shift, and other information used by some GNSS receiver systems.

As mentioned above, the GNSS receiver system, or a device communicatively coupled to the GNSS receiver system, may determine a time of arrival (TOA) of a signal. The GNSS receiver system may also use time of week (TOW) information contained in the navigation message to determine the time when the signal was transmitted by the satellite. From the TOA and TOW information, the GNSS receiver system can determine a transit time of the signal from the satellite to the GNSS receiver system (from which the GNSS receiver system can determine the distance between the GNSS receiver system and the satellite). The GNSS receiver system can also use the ephemeris information to determine the location of the satellite at the time when the signal was transmitted. The process of determining the distance from the GNSS receiver system to a satellite is preferably repeated for multiple satellites and the GNSS receiver system uses the distances to estimate its location as part of the navigation solution.

Theoretically, the location of the GNSS receiver system can be determined using signals from three satellites. However, in practice, GNSS receiver systems typically use signals from four or more satellites to determine a three-dimensional location solution and a time value due to a bias between the GNSS receiver system's clock and the GNSS time. When more than four satellite signals are received, the calculation can use some or all of the satellite signals to increase the accuracy of the solution. Receiving more than four satellite signals also allows the GNSS receiver system to exclude problematic signals from the location calculation without sacrificing the ability to accurately calculate the current position. For example, if 18 satellite signals are received by the GNSS receiver system, more than half of the satellite signals can be excluded from the calculation of the final navigation solution without significantly sacrificing accuracy compared to using all 18 satellite signals. To the contrary, excluding problematic satellite signals can increase, rather than decrease, the accuracy of the calculation.

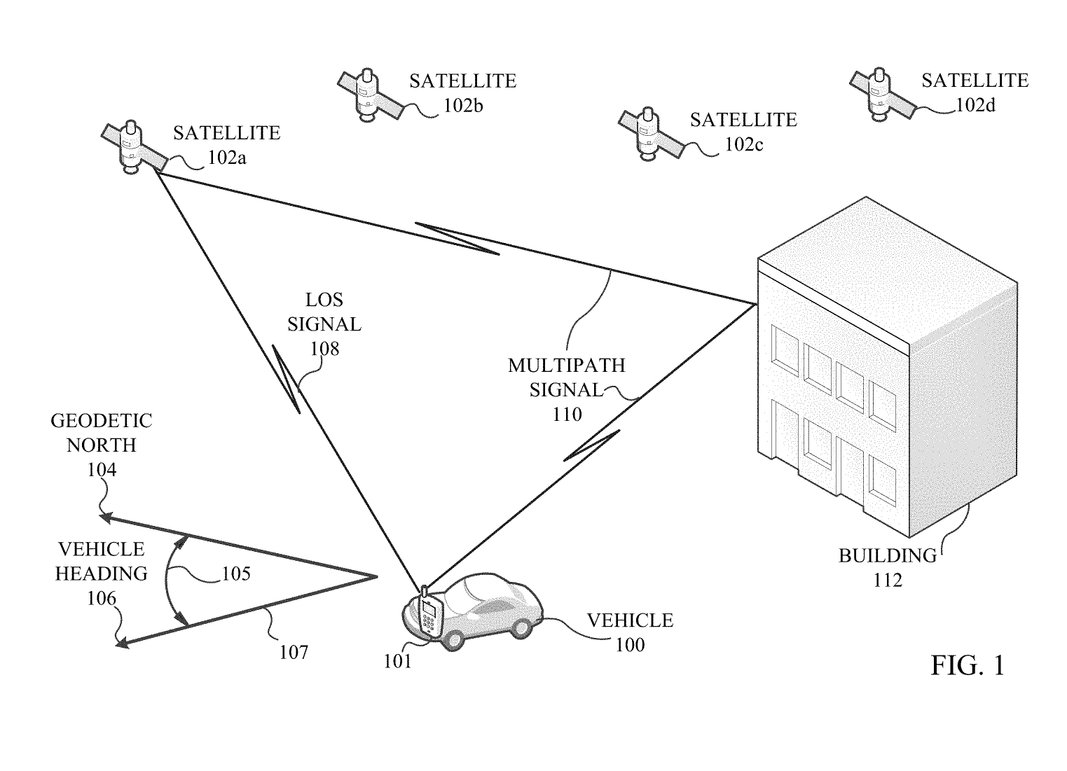

Referring to FIG. 1, a vehicle 100 associated with a global navigation satellite system (GNSS) receiver system 101 is shown traveling through an urban canyon environment created in part by a building 112. Only the building 112 is shown in FIG. 1 for clarity, but an urban canyon environment may be formed from multiple buildings and/or other entities at various locations. The GNSS receiver system 101 receives satellite positioning signals from satellites 102a-d (collectively referred to as satellites 102). For clarity, only a positioning signal from the satellite 102a is shown, with two portions of the positioning signal shown, a line of sight (LOS) signal 108 and a multipath signal 110. The term “LOS vector” refers to a unit vector that points from the GNSS receiver system 101 to the satellite 102a, or vice versa. The term “LOS path” refers to the path from the satellite 102a to the GNSS receiver system 101 along the LOS vector. The term “line of sight direction” or the term “LOS direction” refers to a direction in which the LOS vector points. The positioning signal radiates from the satellite 102a in a radiation pattern determined by an antenna of the satellite 102a, but for clarity only the two different portions of the positioning signal are shown in FIG. 1. The LOS signal 108 is transmitted from the satellite 102a and travels directly to the GNSS receiver system 101, where the LOS signal 108 is received. The multipath signal 110 is transmitted from the satellite 102a, reflects off of the building 112 and is then received by the GNSS receiver system 101. If one or more entities exist in the environment illustrated in FIG. 1, there may be additional multipath signals associated with reflections from those other entities. Accordingly, a single positioning signal may result in multiple signals being received by the GNSS receiver system 101. Additionally, a building may block the LOS path from the satellite 102a to the GNSS receiver system 101, possibly resulting in only the multipath signal 110 being received by the GNSS receiver system 101. While FIG. 1 shows a building reflecting the multipath signal 110, one or more other entities may block or reflect signals from satellites. Non-limiting examples of such entities include vehicles, bridges, trees, or mountains.

The path of the LOS signal 108 and the path of the multipath signal 110 are different lengths, resulting in the multipath signal 110 being a time-delayed version of the LOS signal 108. As described below, the GNSS receiver 101 includes a tracking filter, which may lock on to and track the multipath signal leading to inaccurate data. If this measurement data is input to the Kalman filter used to calculate the location of GNSS receiver system 101, then the final navigation solution will likely be erroneous.

The vehicle 100 is traveling at a velocity comprising a vector quantity consisting of a vehicle heading 106 (that can be characterized by an angle 105 between a vector 107 on the heading 106 and a vector 104 representing geodetic north) and a vehicle speed (represented by a length of the vector 107). The vehicle heading 106 may be determined by GNSS receiver system 101 of vehicle 100 as being the angle 105 with respect to the geodetic north vector 104 or an angle with respect to some other reference direction. The vehicle heading 106 may be determined from any of a variety of sources, including but not limited to, map data, information from inertial sensors such as accelerometers, compasses, etc., previous heading information, heading from successive least squares computations, antenna radiation patterns, etc. As described below, this heading information may be used in conjunction with a Doppler shift of the received positioning signals to remove data from various multipath signals from consideration prior to performing Kalman filtering in order to produce a final navigation solution.

In addition to the LOS signal 108 and the multipath signal 110 having different path lengths (and therefore different arrival times at GNSS receiver system 101), the LOS signal 108 and the multipath signal 110 are received from different directions relative to the vehicle heading 106. Consequently, the frequency of the received LOS signal 108 and the frequency of the received multipath signal 110 are shifted by different amounts due to the Doppler effect. The Doppler effect of the LOS signal 108 measured by the GNSS receiver system 101 is the result of the relative LOS motion of the satellite 102a and the GNSS receiver system 101 along the LOS path, which is the difference between a component of a velocity vector of the satellite 102a along the LOS path and a component of the velocity vector of the GNSS receiver system 101 along the LOS path. The Doppler shift of the multipath signal 110 includes two contributions. The first contribution is due to the relative motion of the satellite 102a and the building 112, which is the difference between a component of a velocity vector of the satellite 102a along the straight line between the satellite 102a and the building 112 and a component of a velocity vector of the building 112 along the same line. The second contribution is due to the relative motion of the GNSS receiver system 101 and the building 112, which is the difference between a component of a velocity vector of the GNSS receiver system 101 along the straight line between the GNSS receiver system 101 and the building 112 and a component of a velocity vector of the building 112 along the same line. In some coordinate systems, the velocity vector of the building 112 may be zero. In other coordinate systems, the building 112 may have a nonzero velocity. As a result of the multiple components of the Doppler shift, the GNSS receiver system 101 will measure a different Doppler shift for the LOS signal 108 and the multipath signal 110. The different Doppler shifts of the received positioning signals can be utilized by GNSS receiver system 101 to identify multipath signals and exclude data from multipath signals from being used in the computation of the final navigation solution.

The Doppler shift due to the relative movement between each satellite and vehicle GNSS receiver system 101 along the respective line of sight can be estimated using equation (1) below:

$${D}_{i} = - ( \frac{{v}_{i} - {v}_{u}}{c} \cdot {1}_{i} ) {L}_{1} \qquad Eqn . ( 1 )$$

where the index i labels each of the various satellites, Dᵢ is the Doppler shift of the positioning signal from the i-th satellite, vᵢ is the satellite velocity, vᵤ is the velocity of the GNSS receiver system, 1ᵢ is the unit LOS vector for the i-th satellite, L₁ is the GPS carrier frequency (e.g., 1575.42 MHz), and c is the speed of light. All the vectors in Eqn. (1) are relative to a global reference point, such as the center of the earth.

The GNSS receiver system 101 can measure the Doppler shift, Dᵢ, for each positioning signal received from each satellite. Each Doppler shift can be converted into a rate of change of the pseudorange, ρᵢ, from the GNSS receiver system 101 to each of the satellites 102, which is called the “delta range.” The delta range, \dot{ρ}₁, (represented by the symbol for the pseudo range, ρᵢ, with a dot above it, representing a derivative with respect to time), is obtained from the measured Doppler shift using equation (2):

$${\dot{ρ}}_{1} = {D}_{i} \times \frac{c}{{L}_{1}} , \qquad Eqn . ( 2 )$$

The GPS carrier frequency L₁ may be known in advance, or may be received as part of the ephemeris information contained in the navigation message.

The measured delta ranges for each of the satellites can be expressed using equation (3):

\dot{ρ}₁=(vᵢ−vᵤ)·1ᵢ+f+εᵢ Eqn. (3)

where f is the GNSS receiver system clock drift relative to the GNSS global time, and εᵢ is the error in the measurement of the delta range of the i-th satellite.

Equation (3) can be rewritten in terms of north east down (NED) and body-fixed (BF) coordinates as shown in equation (4):

$$\begin{matrix}{ψ}_{i} = f - {v}_{f} cos {β}_{i} cos ( {α}_{i} - φ - δφ ) + {ɛ}_{i} \\ = [ 1 - cos {β}_{i} cos ( {α}_{i} - φ - δφ ) ] [ \begin{matrix}f \\ {v}_{f}\end{matrix} ] + {ɛ}_{i}\end{matrix} \qquad Eqn . ( 4 )$$

where αᵢ is the azimuth of the i-th satellite, βᵢ is the elevation of the i-th satellite, φ is the heading of the GNSS receiver system (e.g., vehicle heading 106 shown in FIG. 1), δφ is the error in the heading determination, and v_{f} is the speed of the GNSS receiver system along the LOS unit vector. The second equality of Eqn. (4) is a simple re-writing of the equation using matrix multiplication. The left-hand side of Eqn. (4) is a quantity referred to as a scaled speed value of a measurement vector and is represented by ψᵢ=\dot{ρ}₁−vᵢ·1ᵢ. The scaled speed value of the measurement vector is the i-th component of a measurement vector, where each component of the measurement vector is a scaled speed for each satellite is scaled by a different scaling factor that is a function of each satellite's azimuth and elevation. This quantity, ψᵢ, can be determined from the delta range (determined by the measured Doppler shift as described above) and the satellite velocity and location, which are determined from the ephemeris information. The left-hand side of Eqn. (4) is an equation for one component of the measurement vector. Combining Eqn. (4) with similar equations for the scaled speed values associated with all of satellites 102, the measurement vector can be written in matrix form as in Equation (5):

$$[ \begin{matrix}{ψ}_{1} \\ {ψ}_{2} \\ {ψ}_{3} \\ ⋮ \\ {ψ}_{N}\end{matrix} ] = [ \begin{matrix}1 & - cos {β}_{1} cos ( {α}_{1} - φ - δφ ) \\ 1 & - cos {β}_{2} cos ( {α}_{2} - φ - δφ ) \\ 1 & - cos {β}_{3} cos ( {α}_{3} - φ - δφ ) \\ ⋮ & ⋮ \\ 1 & - cos {β}_{N} cos ( {α}_{N} - φ - δφ )\end{matrix} ] [ \begin{matrix}f \\ {v}_{f}\end{matrix} ] + [ \begin{matrix}{ɛ}_{1} \\ {ɛ}_{2} \\ ⋮ \\ {ɛ}_{N}\end{matrix} ] \qquad Eqn . ( 5 )$$

where N is the number of satellites for which positioning signals are being received by the GNSS receiver system. The left-hand side of Eqn. (5) is referred to as the measurement vector.

Because the scaled speed value the error ψᵢ, the azimuth αᵢ, and the elevation βᵢ are known, the clock offset f and the speed v_{f} of the GNSS receiver system along the LOS vector can be determined if the heading and heading error are known. The heading information can be obtained from a variety of sources, such as a heading sensor that is part of the GNSS receiver system, or a heading sensor external to the GNSS receiver system but that is capable of being communicatively coupled to the GNSS receiver system. For example, the heading sensor could be a sensor of vehicle 100. The heading information may be determined from any of a variety of sources, including but not limited to, map data, information from inertial sensors (e.g., accelerometers, compasses, etc.), dead-reckoning sensors (e.g., gyroscopes and/or steering sensors), previous heading information, heading from successive least squares computations, antenna radiation patterns, etc.

When the vehicle is stationary (or almost stationary), v_{f} becomes ideally 0 (but in practice can be a small, negligible quantity). When the GNSS receiver system is stationary, Eqn. (4) simplifies such that the only unknown variable is the clock drift, f, of the GNSS receiver system. Thus, when the GNSS receiver system is stationary, the clock drift, f, of the GNSS receiver system can be determined.

The velocity of the GNSS receiver system affects the speeds along the LOS vectors v_{f}. Once the clock drift is known, the scaled speed value ψᵢ may be utilized by GNSS receiver 101 to determine the speed of the GNSS receiver system v_{f}, which can then be used to exclude.

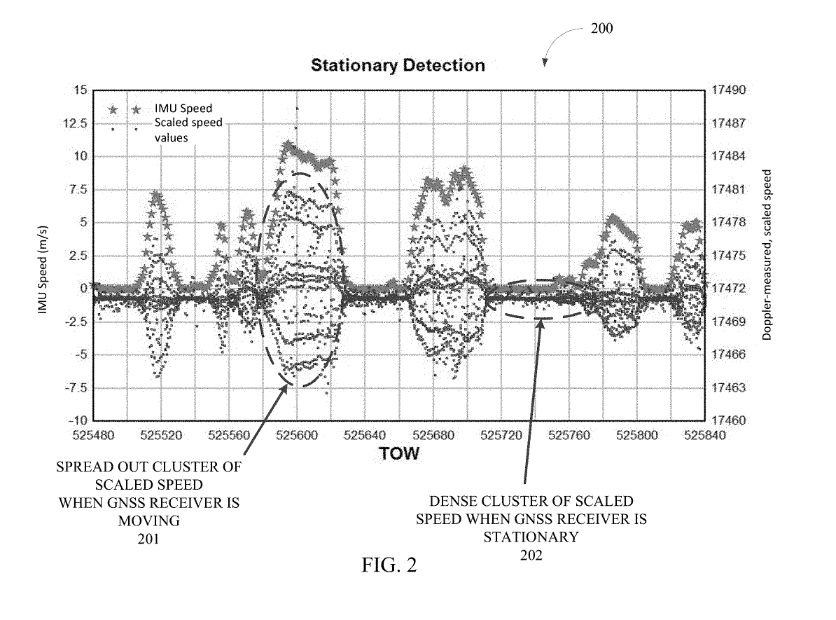

FIG. 2 shows a data plot 200 of scaled speed values ψᵢ (processed from real time data from the GNSS receiver system) that are plotted as a function of time of week (TOW), which is a measurement of the time. Also shown in FIG. 2 is a speed recorded by an inertial measurement unit (IMU) shown as a reference for what the actual speed of the GNSS receiver system was as the scaled speed values ψᵢ were recorded. The velocity of GNSS receiver system changes over time (e.g., the vehicle is stationary in certain time windows, but is moving in other time windows).

When the GNSS receiver system is stationary or almost stationary, the v_{f} term in Eqn. (4) is or approaches zero and the satellite-dependent scaling factor does not play a role, thereby producing a dense cluster 202 of scaled speed values ψᵢ around a mean value that is proportional to the clock drift, f. However, when the vehicle is moving, the v_{f} term in Eqn. (3) is not zero, thereby spreading the cluster of scaled speed values ψᵢ, such as at a region 201, around a mean value at a greater standard deviation than when the GNSS receiver system is stationary. This spread occurs because the scaled speed values ψᵢ for each satellite are scaled by different scaling factors that are functions of each satellite's azimuth and elevation, as described by Eqn. (4). The effect that v_{f} has on the density of the clusters of scaled speed values ψᵢ may be utilized to determine whether the vehicle is stationary or is moving (e.g., when the cluster is dense, it is determined that the vehicle is stationary, but when the cluster is spread out, it is determined that the vehicle is moving). The density of a cluster of scaled speed values ψᵢ may be determined by, for example, using the standard deviation of the data points. If the standard deviation exceeds a threshold value, then the GNSS receiver system is determined not to be stationary. The threshold value may be set manually, e.g., to a number of meters per second. Additionally or alternatively, the noise of the measured speeds may be taken into account when determining the threshold. For example, the threshold may be set relative to (e.g., one times, two times, or other integer or non-integer multiplier times) the standard deviation of the scaled speed values ψᵢ.

If an estimate of the heading of the GNSS receiver system is known, the scaled speed values ψᵢ can be unscaled, resulting in a speed of the GNSS receiver system. The estimate of the heading can be from any number of sources such as the previously computed GNSS heading. Alternatively, the heading can be determined by a compass on-board the vehicle. In yet another example, map data and dead reckoning sensors (e.g. gyroscopes and/or steering sensors) may continuously track the vehicle heading as the vehicle travels down the roadway.

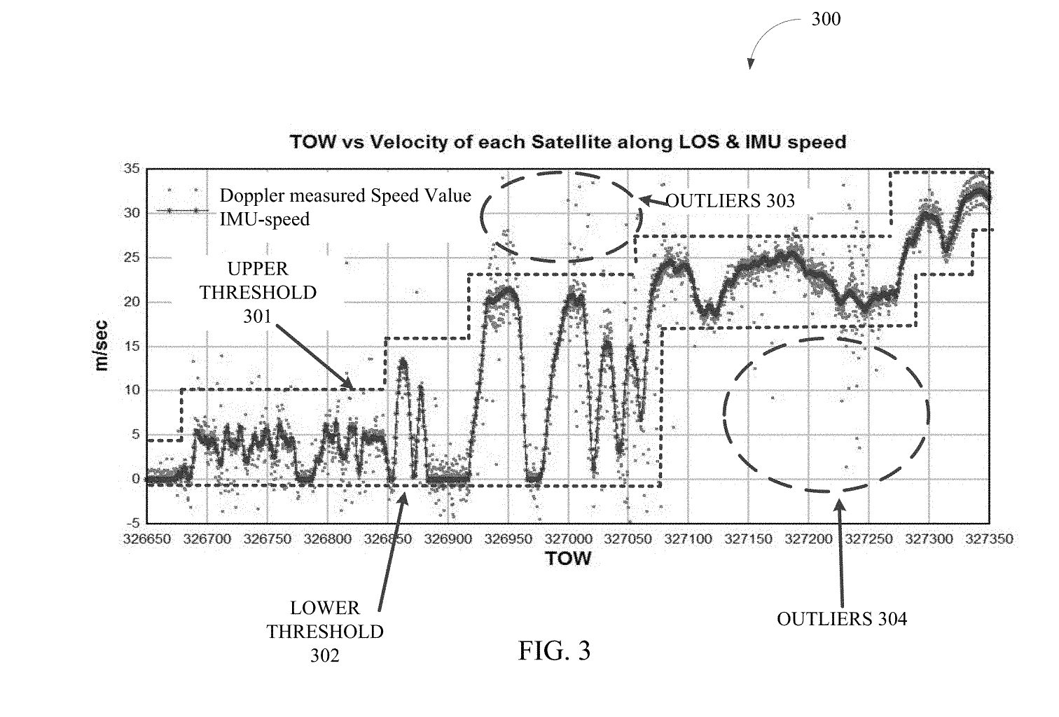

FIG. 3 is a data plot 300 showing the Doppler measured speed for one satellite versus time of week (TOW). The IMU speed is also shown as a reference to illustrate that the speed values determined from the cluster of scaled speed values IN near the speeds measured by an IMU. This clustering may be used to identify multipath signals that yield determined speeds that do not cluster along with the speeds determined from other satellite positioning signals. Satellite positioning signals that are determined to yield speeds that are outliers may be excluded from the calculation of the final navigation solution.

There are many possible techniques that can be used to identify outlier data points (also called simply “outliers”) in the data plot 300 of FIG. 3. Outliers may be estimated using clustering techniques to compute the spread of the speeds and the density of the cluster of data points. Satellite positioning signals associated with speed values that fall outside the cluster may be excluded. For example, the speeds determined based on the scaled speed values can be used to identify an upper threshold 301 and a lower threshold 302. Data points with a speed greater than the upper threshold 301 are determined to be outliers (e.g., the outliers in region 303) and data points with a speed less than the lower threshold 302 are determined to be outliers (e.g., the outliers in region 304). The two thresholds may vary with time (e.g., the time of week (TOW)) as the speed values change over time. For example, the thresholds may be proportional to a standard deviation of the speed measurements for a subset of recent positioning signals from the satellite. In some implementations, the threshold may be equal to a multiple, e.g., one or two times, the standard deviation. The standard deviation may be determined based on most recent measurements, e.g., the 5, 10, or 25 most recent measurements. Other techniques for identifying outliers may also be used. For example, clustering techniques, such as k-means clustering, k-medians clustering, and density-based clustering may be used. Alternatively, a Kalman filter different from the Kalman filter used to determine the final navigation solution may be used to identify outliers.

Other techniques for identifying outliers may not be based on standard deviations, but may be based, for example, on a relative change of the speed value versus the most recent speed values or an average of the most recent speed values. For example, if a speed value associated with a positioning signal is 30 m/s, but the mean of the previous five speed measurements is 10 m/s, it is unlikely that the GNSS receiver system changed speed to be 20 m/s faster over the course of six consecutive receptions of a single positioning signal. Thus, the threshold may be a predetermined difference from a moving average of a certain number of past speed value measurements (e.g., the past 5, 10, 15 or 25 measurements). For example, a speed value may be determined to be an outlier if it differs from the mean of the past 10 speed value measurements by more than 10 m/s, 15 m/s, or 20 m/s.

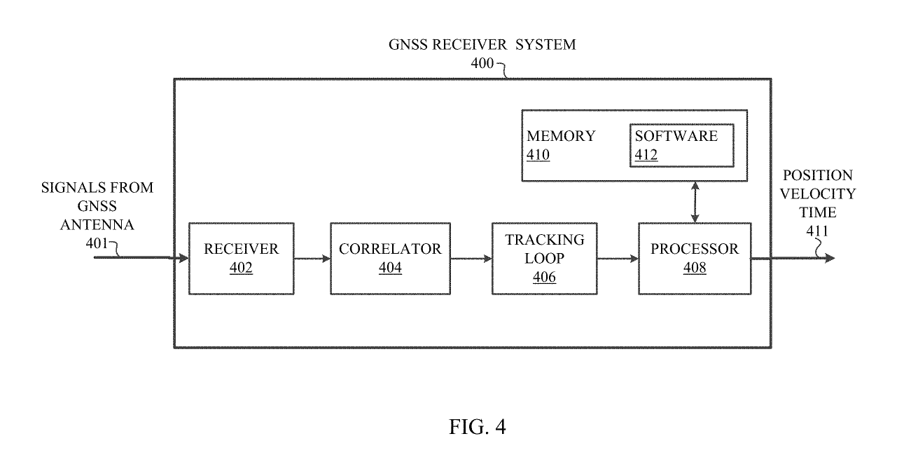

Referring to FIG. 4, an example GNSS receiver system 400 includes a receiver 402, a correlator 404, a tracking loop 406, a processor 408 and a memory 410 including software 412. Although not shown in FIG. 4, the receiver 402 is connected to, and receives GNSS satellite signals 401 from, a GNSS antenna. The receiver 402 is a radio frequency (RF) circuit that is configured to perform RF functions such as down-converting received GNSS satellite signals and providing the down-converted signals to the correlator 404. The processor 408 is preferably an intelligent hardware device, for example a central processing unit (CPU) such as those made or designed by QUALCOMM®, ARM®, Intel® Corporation, or AMD®, a microcontroller, an application specific integrated circuit (ASIC), etc. The processor 408 may comprise multiple separate physical entities that are communicatively coupled to one another. The memory 410 may include random access memory (RAM) and/or read-only memory (ROM). The memory 410 is a non-transitory, processor-readable storage medium that stores the software 412 which is processor-readable, processor-executable software code containing instructions that are configured to, when performed, cause the processor 408 to perform various functions described herein (although the description may refer only to the processor 408 performing the functions). The software 412 may not be directly executable by the processor 408 and instead may be configured to, for example when compiled and executed, cause the processor 408 to perform the functions. Whether needing compiling or not, the software 412 contains the instructions to cause the processor 408 to perform the functions. The processor 408 is communicatively coupled to the memory 410. The processor 408 in combination with the memory 410 provide means for performing functions as described herein, for example, receiving a positioning signal from the tracking loop, determining speed values, determining if a speed value is an outlier and determining the position of GNSS receiver system 400.

The receiver 402 is configured to acquire positioning signals from multiple satellites. Positioning signals from satellites are spread spectrum signals comprising a pseudo-noise (PN) code, where each satellite has a different PN code. The correlator 404 is configured to generate a replica code and align the replica code with the received positioning signal to compute a correlation signal. The tracking loop 406 is configured to receive the correlation signal from correlator 404 and implement a delay-locked loop that adjusts the replica-code to keep it aligned with the code in the incoming signal. After alignment is accomplished, the code may be removed from the signal leaving the carrier modulated by the navigation message. The tracking loop 406 is also configured to implement a phase-locked loop and/or a frequency-locked loop to determine the frequency of the received signal, which can be used by the processor 408 to calculate the Doppler shift of the received signal.

The processor 408 is configured to read the satellite clock time from the navigation message included in the positioning signal to determine when the positioning signal was generated at the satellite. The processor 408 is also configured to utilize the computed time at the GNSS receiver system 408 to determine when the positioning signal was received. Multiplying the apparent transit times by the speed of light gives the pseudoranges of the satellites. The processor 408 is configured to implement a location algorithm (e.g., Kalman Filter, least squares estimation, etc.) to compute a final navigation solution, which includes the location, velocity and time of GNSS receiver system 400.

In an example, processor 408 may utilize instructions from memory 410 to estimate the location, velocity and time of GNSS receiver system 400 by using a least squares estimation based on the computed pseudoranges. In another example, processor 408 utilizes instructions from memory 410 to implement a Kalman filter that estimates the location, velocity and time of the GNSS receiver by using a time series of pseudorange measurements and optional dead reckoning sensors. In either scenario, the estimated position, velocity and/or time 411 of GNSS receiver system 400 may then be output by processor 408 to a navigation system of the vehicle (e.g., if the GNSS receiver system 400 is integrated within the vehicle), or to other components of a mobile device (e.g., if the GNSS receiver system 400 is integrated in a mobile device such as a smartphone or tablet).

The processor 408 is configured to classify positioning signals as multipath signals. For example, the processor 408 may be configured to classify a positioning signal as a multipath signal based on the measured Doppler shift of the signal and the ephemeris information for the corresponding satellite 102. As a further example, the processor 408 may be configured to classify a positioning signal as a multipath signal by determining, using the Doppler shift of the positioning signal, that a speed of the receiver system 400 relative to the satellite as determined using the positioning signal is an outlier compared to the relative speed of the receiver system 400 determined from other positioning signals from that satellite.

The processor 408 is preferably configured not to use information from positioning signals that are classified as multipath signals. For example, the processor 408 may be configured not to use information from positioning signals that satisfy a criterion. For example, the criterion may be that a speed determined using the positioning signal is determined to be an outlier relative to the speed determined using other received positioning signals from the same satellite.

While processor 408 is included in the GNSS receiver system 400 in FIG. 4, some implementations may perform some or all of the aforementioned processing using a processor that is not included in the GNSS receiver system 400. Furthermore, the processor 408 may be a dedicated GNSS processor or a processor that performs other tasks, such as application level processing.

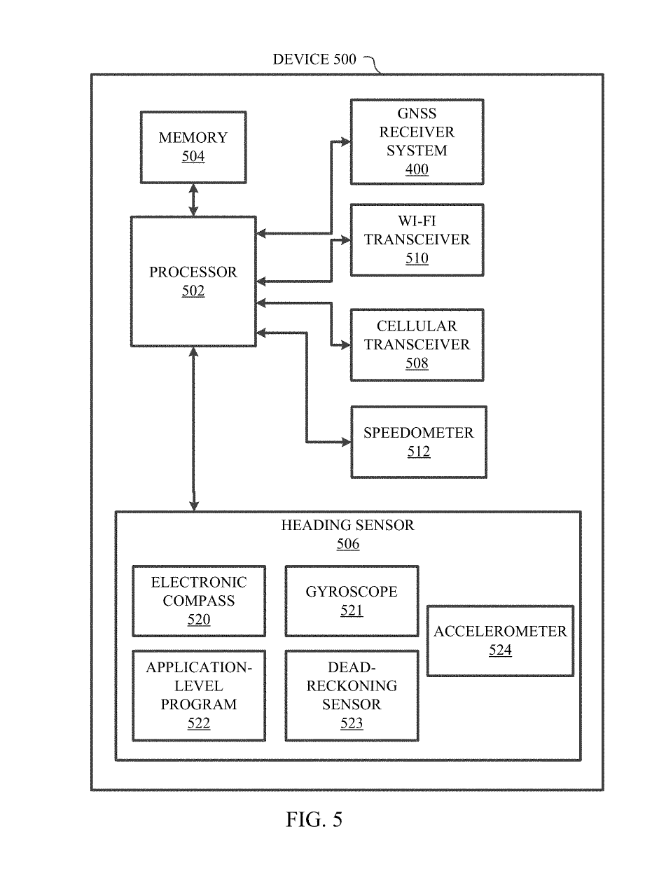

FIG. 5 is a block diagram of a device that includes the GNSS receiver system 400 from FIG. 4. The device may be, for example, a mobile device, a cellular telephone, a smartphone, or an in-vehicle navigation system. The device 500 may include processor 502, memory device 504, cellular transceiver 508, Wi-Fi transceiver 510, heading sensor 506, and speedometer 512, among other elements that are not shown. While the heading sensor 506 is shown external to GNSS receiver system 400 in FIG. 5, it may instead be included as part of the GNSS receiver system 400.

As described above, the device 500 may be a smartphone, or an in-vehicle device which may be integrated into the vehicle (e.g., vehicle head unit/navigation/communication system), or may not be integrated in the vehicle (e.g., external navigation device, tablet computer, mobile phone, etc.). The speedometer 512 may be a part of the vehicle itself or part of the device 500.

The cellular transceiver 508, Wi-Fi transceiver 510, heading sensor 506 may be integral to the device 500 or separate from and connected to the device 500 via a wired or wireless interface. In either case, processor 502 controls the various components within the device 500. Memory 504 may include software instructions and other data stored for access by processor 502. The heading sensor 506 may include an electronic compass 520, a gyroscope 521, an application-level program 522 that includes map data, a dead-reckoning sensor 523, and accelerometer 524. The heading sensor 506 may also include additional ccelerometers, a steering angle sensor, a wheel speed sensor, an inclination sensor, a brake sensor, a light sensor, a sound sensor, or an altitude sensor, or a combination thereof, which are not shown in FIG. 5.

In addition to GNSS receiver 400, the device 500 includes cellular transceiver 508 and Wi-Fi transceiver 510 for receiving wireless communications via cellular RF transmissions and Wi-Fi transmissions, respectively. These transceivers may allow the device 500 to both transmit signals to and receive signals from other wireless devices using various wireless communication formats.

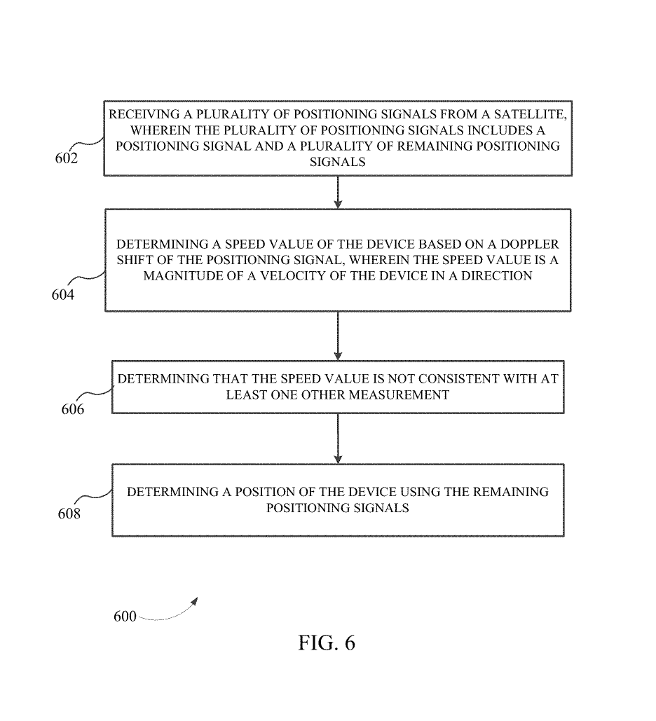

Referring to FIG. 6, with further reference to FIGS. 1-5, a method 600 of operating a device that include a GNSS receiver system or communicates with a GNSS receiver system includes the stages shown. The method 600 is an example and not limiting of the disclosure. One or more stages may be added, removed, or rearranged. The method 600 may be implemented using the GNSS receiver system 400 or a device that is communicatively coupled to a GNSS receiver system 400. Furthermore, instructions for performing one or more of the stages in the method 600 may be stored as processor-readable instructions in a non-transitory processor-readable memory, such as the memory 410.

At stage 602, the method 600 includes receiving multiple positioning signals from a satellite, wherein the positioning signals includes a positioning signal and multiple remaining positioning signals. For example, as described above in connection with FIG. 1, satellites 102 send positioning signals that are received by GNSS receiver system 101. A particular satellite 102a sends multiple positioning signals over time. Each positioning signal transmitted by satellite 102a includes at least a part of a navigation message, which can be used by the GNSS receiver system 101 to determine the range from the GNSS receiver system 102 to the satellite 102a. Over a period of time, the GNSS receiver system 101 receives the positioning signal and multiple remaining positioning signals. The multiple remaining positioning signals include a subset of the positioning signals received by the device that do not include the positioning signal or any other signal that is determined to be not consistent with at least one other measurement, as described below. The other satellites 102b-d also send multiple positioning signals containing other navigation messages and the method 600 can also be applied to the positioning signals received from the satellites 102b-d.

At stage 604, the method 600 includes determining a speed value of the device based on a Doppler shift of the positioning signal, wherein the speed value is a magnitude of a velocity of the device in a direction. For example, as discussed above in connection with Eqns. (1)-(5), a rate of change of the pseudorange between a satellite and the GNSS receiver system (referred to as the “delta range”) can be determined from the Doppler shift of the positioning signal using Eqn. (2). The delta range is related to the velocity of the GNSS receiver system 101 using Eqn. (3), which can be re-arranged and re-written as shown in Eqn. (4). The speed of the GNSS receiver system 101 along the LOS unit vector, v_{f}, is the speed value and can be determined when the other variables in Eqn. (4) are known. The other variables are known from the Doppler shift measurement, the ephemeris information associated with the satellite, and a measurement of the heading of the GNSS receiver system 101, e.g., from a heading sensor.

The Doppler shift may be determined by measuring the received frequency of the positioning signal and comparing the measured value of the received frequency to the carrier frequency used by the satellite when transmitting the positioning signal. The Doppler shift is the difference between the measured value of the received frequency and the carrier frequency. The received frequency of the positioning signal is measured in the tracking loop 406 of GNSS receiver system 400 by, for example, a phase-locked loop or a frequency-locked loop. The value of the measured frequency can be sent to processor 408 for comparison with the carrier frequency used by the satellite. The carrier frequency may be determined from the ephemeris information contained in the navigation message of the positioning signal or may be predetermined and stored in the memory 310 of GNSS receiver system 400.

The heading of the GNSS receiver system can be determined by a heading sensor within the GNSS receiver system 400 that communicates heading information to the processor 408. Alternatively, a heading sensor 506 may be external to the GNSS receiver system 400 (e.g., the heading sensor 506 can be part of a device 500). An external heading sensor 506 can communicate heading information to the processor 408 of GNSS receiver system 400 via an interface.

As discussed in connection with FIG. 2, the clock drift of the GNSS receiver system, f, can be determined from the Doppler measurement when the GNSS receiver system is stationary. For example, the clock drift of the GNSS receiver system can be determined from the scaled speed values ψᵢ at times the GNSS receiver system is stationary. The clock drift of the GNSS receiver system can be determined in this way at various times and stored in memory 410 for use when determining the speed value. The clock drift of the GNSS receiver system can be determined in other ways known in the art and need not be determined in the way described in connection with FIG. 2.

At stage 606, the method 600 includes determining that the speed value is not consistent with at least one other measurement. The at least one other measurement may include remaining speed values of the device determined based on Doppler shifts of respective ones of the remaining positioning signals. The speed value is determined to be not consistent with the remaining speed values if the speed value is determined to be an outlier relative to the remaining speed values. The remaining speed values are magnitudes of velocities of the GNSS receiver system in respective directions, for example along the line of sight from the device to the satellite at the time the respective positioning signal is received. The speed value could be determined to be consistent with the remaining speed values if the speed value is determined not to be an outlier relative to the remaining speed values.

Determining whether a speed value is consistent with the at least one other measurement, can be performed as described above in connection with FIG. 3. For example, when the speed value is determine to be consistent with multiple other remaining speed values, the speed value is compared with the multiple other speed values (referred to as “remaining speed values”) of the GNSS receiver system that are determined in a similar manner as the speed value, but using a respective positioning signal from the multiple other positioning signals received from the same satellite. The multiple other remaining speed values are speeds measured in the same direction as the direction along which the first speed value is determined. This direction is, for example, the LOS direction between the GNSS receiver system and the satellite.

As described above, one or more clustering techniques may be used to determine whether the speed value is an outlier. Alternatively, the multiple other remaining speed values associated with positioning signals received proximate in time to the time at which the positioning signal was received may be used to create a moving average and standard deviation to which the speed value is compared to determine if it is an outlier. For example, the moving average and/or standard deviation of the most recent 5, 10, 15 or 25 speed values may be used to calculate upper and lower thresholds. If the speed value is greater than the upper threshold or less than the lower threshold, then the speed value is determined to be an outlier. In this way, the upper threshold and lower threshold are based on the multiple other speed values and may change as a function of time (see FIG. 3).

Alternatively or additionally, the at least one other measurement may include a measured speed from the speedometer 512 and a heading measurement from the heading sensor 506. An other speed value of the GNSS receiver system relative to the satellite along the line of sight direction may be calculated using the measured speed from the speedometer 512 and the heading from the heading sensor 506, as well as the ephemeris information about the orbital data of the satellite. If the speed value differs from the other speed value by a threshold amount, then the speed value is determined to be inconsistent with the measurements made by the speedometer 512 and the heading sensor 506.

At stage 608, the method 600 includes determining the position of the device using the remaining positioning signals. The remaining positioning signals are a subset of the received positioning signals that do not include positioning signals determined to have speed values that are inconsistent with the at least one other measurement. Thus, the position of the device is determined without using the positioning signal associated with the speed value that is determined to be not consistent with the at least one other measurement. For example, if the processor 408 were to determine that the speed value is consistent with the at least one other measurement, then the positioning signal from which the first speed value was determined may be included in the input data used to calculate the final navigation solution. While not discussed herein, the positioning signal may be excluded from the input to the calculation of the final navigation for other reasons, e.g., not meeting some other criterion unrelated to the Doppler shift. As discussed above, determining the final navigation solution includes determining the location of the GNSS receiver system using a least squares technique or a Kalman filter.

In this way, the positioning signals which are determined not to be consistent with the at least one other measurement are excluded from the calculation of the final navigation solution. By excluding information from the inconsistent positioning signals, the information of the inconsistent positioning signals remains stored in memory, but is not used for determining the location of the GNSS receiver system. Alternatively, the inconsistent positioning signal may be discarded and corresponding information deleted from memory in response to the processor 408 determining that the speed value is inconsistent with the at least one other measurement.

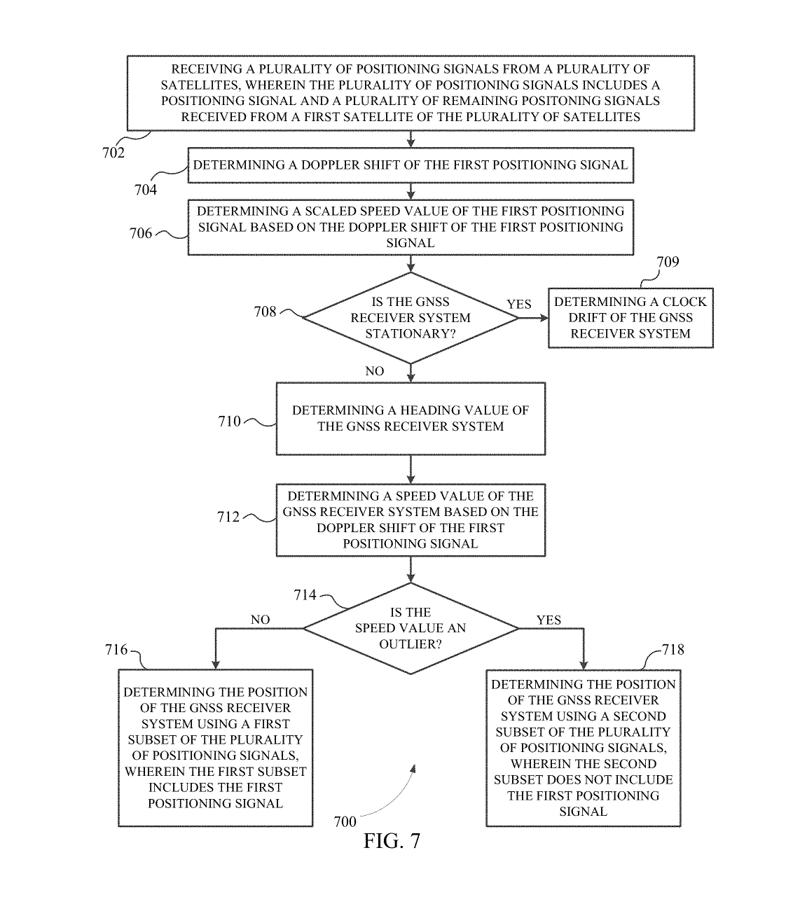

Referring to FIG. 7, with further reference to FIGS. 1-6, a method 700 of operating a GNSS receiver system includes the stages shown. The method 700 is an example and not limiting of the disclosure. One or more stages may be added, removed, or rearranged. The method 700 may be implemented using the GNSS receiver system 400 and/or instructions for performing one or more of the stages in method 700 may be stored in a non-transitory computer-readable memory, such as memory 410. The method 700 is an example of the method 600 illustrated in FIG. 6.

At stage 702, the method 700 includes receiving multiple positioning signals from multiple satellites, wherein the positioning signals includes a first positioning signal and a plurality of remaining positioning signals received from a first satellite of the plurality of satellites. For example, as described above, GNSS receiver system 400 receives positioning signals at regular intervals from multiple satellites (e.g., satellites 102 of FIG. 1). The GNSS receiver system 400 receives the positioning signals using an antenna and the receiver 402.

At stage 704, the method 700 includes determining a Doppler shift of the first positioning signal. The Doppler shift can be determined, for example, by processor 408 by finding a difference between the frequency of the first positioning signal measured by the tracking loop 406 and the carrier frequency of the first positioning signal. The carrier frequency may be obtained from the ephemeris information or may be predetermined. The processor 408 may determine the Doppler shift of positioning signals received by the GNSS receiver system 400, including positioning signals other than the first positioning signal transmitted by the first satellite and positioning signals transmitted by the other satellites 102. The Doppler shift of each of the multiple received positioning signals can be determined in the same way that the Doppler shift of the first positioning signal is determined.

At stage 706, the method 700 includes determining a scaled speed value of the first positioning signal based on the Doppler shift of the first positioning signal. The scaled speed value can be determined, for example, by processor 408 by converting the Doppler shift into a rate of change of the pseudorange (also referred to as the delta range) and subtracting the velocity of the satellite along the line of sight between the transmitting satellite 102 and the GNSS receiver system 400. As described above, this calculation is based on the formula ψᵢ=\dot{ρ}vᵢ·1ᵢ. The information necessary to determine the velocity of the satellite 102 along the line of sight is contained in the ephemeris information. The processor 408 may determine a scaled speed value for every positioning signal received by the GNSS receiver system 400, including positioning signals other than the first positioning signal transmitted by the first satellite and positioning signals transmitted by the other satellites 102. The scaled speed value of each of the multiple received positioning signals can be determined in the same way that the scaled speed value of the first positioning signal is determined.

At stage 708, the method 700 includes determining whether the GNSS receiver system is stationary. This may be accomplished, for example, at processor 408 by comparing the spread of the scaled speed values ψᵢ as described in connection with FIG. 2. When the scaled speed values ψᵢ are closely grouped with a standard deviation less than a threshold value (as in region 202 of FIG. 2), the GNSS receiver system 400 is determined to be stationary. Alternatively, the GNSS receiver system 400 can receive an indication that the GNSS receiver system 400 is stationary from a sensor (e.g., a speedometer or an inertial measurement unit (IMU)) of the device 500 in which the GNSS receiver system 400 is included.

If the GNSS receiver system is determined to be stationary at stage 708, then the method continues to stage 709 where the method 700 includes determining a clock drift of the GNSS receiver system. For example, as discussed above in connection with FIG. 4, when the GNSS receiver system 400 is stationary, the scaled speed value is directly related to the clock drift of the GNSS receiver system 400 relative to the GNSS global time. Processor 408 calculates the clock drift of the GNSS receiver system 400 based on this relationship.

If the GNSS receiver system is determined to be non-stationary at stage 708, then the method 700 continues to stage 710 where the method 700 includes determining a heading value of the GNSS receiver system. For example, the heading information may be determined by a variety of techniques, including but not limited to, map data, information from inertial sensors (e.g., accelerometers, compasses, etc.), dead-reckoning sensors (e.g., gyroscopes and/or steering sensors), previous heading information, heading from successive least squares computations, antenna radiation patterns, etc. The sensors may be part of the GNSS receiver system 400 or external to the GNSS receiver system 400. For example, the sensors may be part of the device 500 and communicatively coupled to the GNSS receiver system 400. Processor 408 may be used to calculate the heading from information received from one or more sensors, or processor 408 may receive the heading from a sensor. Furthermore, one sensor may be used or a combination of multiple sensors may be used to determine the heading.

At stage 712, the method 700 includes determining a speed value of the GNSS receiver system based on the Doppler shift of the first positioning signal. This may be accomplished, for example, by processor 408 using Eqn. (4) and/or Eqn. (5). As described above, the measurement value of the first positioning signal (which is itself based on the Doppler shift of the first positioning signal) can be used in connection with the heading of the GNSS receiver system 400, the azimuth and elevation of the satellite 102, the error in the heading of the GNSS receiver system 400 and the error in the scaled speed value to determine a speed value of the GNSS receiver system 400. Speed values for the remaining positioning signals received by the GNSS receiver system 400 may be determined in similar ways. Furthermore speed values for positioning signals received from satellites other than the first satellite may be determined. The speed values of each of the multiple received positioning signals can be determined in the same way that the speed value based on the first positioning signal is determined.

At stage 714, the method 700 includes determining whether the speed value is an outlier. This may be accomplished, for example, by processor 408 as described in connection with FIG. 4. As described in connection with FIG. 6, the speed value of the GNSS receiver system 400 determined based on the Doppler shift of the first positioning signal may be determined to be an outlier relative to multiple speed values of the GNSS receiver system 400 determined based on Doppler shifts of the positioning signals received from the satellites. For example, an outlier speed value may be any speed value that is greater than an upper threshold or less than a lower threshold. Alternatively, a clustering algorithm, such as a k-means clustering, may be performed to identify outliers in the speed values determined from signals from the multiple satellites 102.

If the speed value of the first positioning signal is determined to be an outlier, then the first positioning signal is excluded from the calculation of the final navigation solution. If the speed value of the first positioning signal is determined at stage 714 not to be an outlier, then the method 700 continues to stage 716 where the method 700 includes determining the position of the GNSS receiver system using a first subset of the positioning signals, wherein the first subset includes the first positioning signal. If the speed value of the first positioning signal is determined at stage 714 to be an outlier, then the method 700 continues to stage 718 where the method 700 includes determining the position of the GNSS receiver system using a second subset of the positioning signals, wherein the second subset does not include the first positioning signal. In this way, the first positioning signal is excluded from the subset of positioning signals used to calculate the position of the GNSS receiver system.

In both stage 716 and stage 718, the position of the GNSS receiver system is determined as part of the final navigation solution, e.g., as calculated by processor 408. For example, this determination may include using a Kalman filter to calculate the location of the GNSS receiver system 400. The input to the Kalman filter is either the first subset of positioning signals or the second subset of positioning signals, depending on the outcome of the determining at stage 714. The word subset is used here to mean a set of positioning signals that is equal to or less than the original set of positioning signals. Thus, even if no positioning signals are excluded from the input of the Kalman filter, the set of input positioning signals is still referred to as a subset.

Other Considerations

Although FIG. 1 describes the system with the use of Earth orbiting satellites, pseudo-satellites (e.g., ground stations that transmit GNSS signals) may be used in place of, or in conjunction with, Earth orbiting satellites. In operation, these pseudo-satellites essentially mimic the signals transmitted by the Earth orbiting satellites. For example, each pseudo-satellite may transmit a navigation message containing the time when the message was transmitted, ephemeris information which includes details about corrections for the pseudo-satellite's clock, and a spread spectrum signal comprising a unique PN code that may identify each pseudo-satellite. The overall processing as described with respect to FIGS. 1-6 will be essentially the same when using the pseudo-satellites.

Additionally, although the above description discusses excluding multipath positioning signals from the calculation of the GNSS final navigation solution, the same techniques can be used to exclude positioning signals that are erroneous due to a low signal-to-noise ratio.

Although the GNSS receiver system 400 is illustrated and described herein with reference to specific examples, the disclosure is not limited to the details shown. Rather, various modifications may be made in the details within the scope and range of equivalents of the claims.

As used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions.

The processes, systems, and devices discussed above are examples. Various configurations may omit, substitute, or add various procedures or components as appropriate. For instance, in alternative configurations, the processes may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the some of the above embodiments. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed is:

1. A device comprising:
a receiver configured to receive a plurality of positioning signals from a satellite, wherein the plurality of positioning signals includes a positioning signal and a plurality of remaining positioning signals; and
a processor, communicatively coupled to the receiver, configured to:
determine a speed value of the device based on a Doppler shift of the positioning signal, wherein the speed value is a magnitude of a velocity of the device in a direction;
determine that the speed value is not consistent with at least one other measurement; and
determine a position of the device using the plurality of remaining positioning signals.

2. The device of claim 1, wherein the at least one other measurement comprises:
a plurality of remaining speed values of the device determined based on Doppler shifts of respective ones of the plurality of remaining positioning signals, wherein the plurality of remaining speed values are magnitudes of velocities of the device in respective directions.

3. The device of claim 2, wherein the processor is configured to determine that the speed value is not consistent with the at least one other measurement by determining that the speed value is an outlier relative to the plurality of remaining speed values.

4. The device of claim 3, wherein the processor is further configured to determine that the speed value of the device is an outlier if the speed value of the device is greater than an upper threshold or less than a lower threshold.

5. The device of claim 4, wherein the processor is further configured to determine the upper threshold and the lower threshold based on the plurality of remaining speed values.

6. The device of claim 5, wherein the processor is further configured to determine the upper threshold and the lower threshold based on a standard deviation of the plurality of remaining speed values.

7. The device of claim 1, wherein the speed value is the magnitude of the velocity of the device in a line of sight direction from the device to the satellite.

8. The device of claim 7, wherein the processor is further configured to determine a heading of the device, and wherein to determine the speed value of the device the processor is configured to use the heading of the device.

9. The device of claim 8, wherein to determine the speed value the processor is configured to calculate:
$$ψ = [ 1 - cos β cos ( α - φ - δφ ) ] [ \begin{matrix}f \\ {v}_{f}\end{matrix} ] + ɛ$$
where
α is an azimuth of the satellite;
β is an elevation of the satellite;
φ is the heading of the device;
δφ is an error in a measurement of the heading, φ;
v_{f} is the speed value being determined;
f is a clock drift of the device relative to the satellite;
ψ is a measured quantity related to the Doppler shift of the positioning signal; and
ε is an error in ψ due to the device.

10. The device of claim 8, further comprising a heading sensor, wherein to determine the heading of the device the processor is configured to receive the heading from the heading sensor, wherein the heading sensor comprises at least one of an electronic compass, a gyroscope, map data from an application-level program, or a dead-reckoning sensor.

11. The device of claim 10, wherein the at least one other measurement comprises:
a measured speed of the device received from a speedometer; and
the heading received from the heading sensor.

12. The device of claim 11, wherein the processor is configured to determine that the speed value is not consistent with the at least one other measurement by:
calculating an other speed value of the device relative to the satellite along the line of sight direction using the measured speed and the heading; and
determining that the speed value is not within a threshold value from the calculated other speed value.

13. The device of claim 1, wherein the processor is further configured to determine a clock drift of the device in response to the device being stationary.

14. A method of operating a device, the method comprising:
receiving a plurality of positioning signals from a satellite, wherein the plurality of positioning signals includes a positioning signal and a plurality of remaining positioning signals;
determining a speed value of the device based on a Doppler shift of the positioning signal, wherein the speed value is a magnitude of a velocity of the device in a direction;
determining that the speed value is not consistent with at least one other measurement; and
determining a position of the device using the plurality of remaining positioning signals.

15. The method of claim 14, wherein the at least one other measurement comprises:
a plurality of remaining speed values of the device determined based on Doppler shifts of respective ones of the plurality of remaining positioning signals, wherein the plurality of remaining speed values are magnitudes of velocities of the device in respective directions.

16. The method of claim 15, wherein determining that the speed value is not consistent with the at least one other measurement comprises determining that the speed value is an outlier relative to the plurality of remaining speed values.

17. The method of claim 16, further comprising:
determining that the speed value is an outlier if the speed value of the device is greater than an upper threshold or less than a lower threshold.

18. The method of claim 17, further comprising determining the upper threshold and the lower threshold based on the plurality of remaining speed values.

19. The method of claim 18, further comprising determining the upper threshold and the lower threshold based on a standard deviation of the plurality of remaining speed values.

20. The method of claim 14, wherein the speed value is the magnitude of the velocity of the device in a line of sight direction from the device to the satellite.

21. The method of claim 20, wherein the method further comprises determining a heading of the device, and wherein determining the speed value of the device is based on the heading of the device.

22. The method of claim 21, wherein determining the speed value comprises calculating:
$$ψ = [ 1 - cos β cos ( α - φ - δφ ) ] [ \begin{matrix}f \\ {v}_{f}\end{matrix} ] + ɛ$$
where,
α is an azimuth of the satellite;
β is an elevation of the satellite;
φ is the heading of the device;
δφ is an error in a measurement of the heading, φ;
v_{f} is the speed value being determined;
f is a clock drift of the device relative to the satellite;
ψ is a measured quantity related to the Doppler shift of the positioning signal; and
ε is an error in ψ due to the device.

23. The method of claim 21, wherein determining the heading of the device comprises receiving the heading from a heading sensor, wherein the heading sensor comprises at least one of an electronic compass, a gyroscope, map data from an application-level program, or a dead-reckoning sensor.

24. The method of claim 23, wherein the at least one other measurement comprises:
a measured speed of the device received from a speedometer; and
the heading received from the heading sensor.

25. The method of claim 24, wherein determining that the speed value is not consistent with the at least one other measurement comprises:
calculating an other speed value of the device relative to the satellite along the line of sight direction using the measured speed and the heading; and
determining that the speed value is not within a threshold value from the calculated other speed value.

26. The method of claim 14, wherein the method further comprises determining a clock drift of the device in response to the device being stationary.

27. A non-transitory processor-readable storage medium for a device with processor-readable instructions stored thereon, wherein the processor-readable instructions are configured to cause a processor to:
receive a plurality of positioning signals from a satellite, wherein the plurality of positioning signals includes a positioning signal and a plurality of remaining positioning signals;
determine a speed value of the device based on a Doppler shift of the positioning signal, wherein the speed value is a magnitude of a velocity of the device in a direction;
determine that the speed value is not consistent with at least one other measurement; and
determine a position of the device using the plurality of remaining positioning signals.

28. The non-transitory processor-readable storage medium of claim 27, wherein the at least one other measurement comprises:
a plurality of remaining speed values of the device determined based on Doppler shifts of respective ones of the plurality of remaining positioning signals, wherein the plurality of remaining speed values are magnitudes of velocities of the device in respective directions.

29. The non-transitory processor-readable storage medium of claim 28, further comprising instructions to determine that the speed value is not consistent with the at least one other measurement by determining that the speed value is an outlier relative to the plurality of remaining speed values.

30. A device comprising:
means for receiving a plurality of positioning signals from a satellite, wherein the plurality of positioning signals includes a positioning signal and a plurality of remaining positioning signals;
means for determining a speed value of the device based on a Doppler shift of the positioning signal, wherein the speed value is a magnitude of a velocity of the device in a direction;
means for determining that the speed value is not consistent with at least one other measurement; and
means for determining a position of the device using the plurality of remaining positioning signals.
